(19) United States
(12) Patent Application Publication
(10) Pub. No.: US 2018/0284924 A1
(43) Pub. Date: Oct. 4, 2018

(54) DISPLAY DEVICE

(71) Applicant: Japan Display Inc., Tokyo (JP)

(72) Inventors: Yoshihiro WATANABE, Tokyo (JP); Yoshikatsu IMAZEKI, Tokyo (JP); Yoichi KAMIJO, Tokyo (JP); Shuichi OSAWA, Tokyo (JP)

(21) Appl. No.: 15/938,608

(22) Filed: Mar. 28, 2018

(30) Foreign Application Priority Data
Mar. 29, 2017 (JP) 2017-064692
Nov. 27, 2017 (JP) 2017-227229

(51) Int. Cl. G06F 3/044; G02F 1/1333; G02F 1/1362; G02F 1/1345; G06F 3/041

(52) U.S. Cl. CPC G06F 3/044; G02F 1/13338; G02F 1/136286; G06F 2203/04111; G06F 3/0412; G02F 2201/42; G02F 1/13452

(57) ABSTRACT

According to one embodiment, a display device includes a first substrate which includes a first basement and a first conductive layer, a second substrate which includes a second basement having a first hole and a second conductive layer, and a connecting material which electrically connects the first conductive layer and the second conductive layer via the first hole. On a first plane, an angle between a first straight line and a second straight line is greater than or equal to 45°.

### CROSS-REFERENCE TO RELATED APPLICATIONS

This application is based upon and claims the benefit of priority from Japanese Patent Applications No. 2017-064692, filed Mar. 29, 2017; and No. 2017-227229, filed Nov. 27, 2017, the entire contents of all of which are incorporated herein by reference.

### FIELD

Embodiments described herein relate generally to a display device.

### BACKGROUND

Recently, various techniques for narrowing the frames of display devices have been considered. One of the techniques is a technique of electrically connecting a wiring line having an in-hole connector in a hole penetrating the inner surface and outer surface of a first resin substrate, and a wiring line provided on the inner surface of a second resin substrate, by an inter-substrate connector.

### SUMMARY

The present disclosure generally relates to a display device.

According to one embodiment, a display device includes a first substrate which includes a first basement and a first conductive layer, a second substrate which includes a second basement having a first hole and a second conductive layer, and a connecting material which electrically connects the first conductive layer and the second conductive layer via the first hole. On a first plane, an angle between a first straight line and a second straight line is greater than or equal to 45°.

### BRIEF DESCRIPTION OF THE DRAWINGS

FIG. 1 is a plan view showing an example of the structure of a display device according to the first embodiment.

FIG. 2 is a plan view schematically showing the basic structure and the equivalent circuit of a display panel shown in FIG. 1.

FIG. 3 is a sectional view showing a display area of the display panel shown in FIG. 1.

FIG. 4 is a plan view showing an example of the structure of a sensor according to the first embodiment.

FIG. 5 is a sectional view showing the display device taken along line V-V of FIG. 1.

FIG. 6 is a plan view showing a second conductive layer and a second surface shown in FIG. 5.

FIG. 7 is a plan view showing a contact hole and the second surface shown in FIG. 5.

FIG. 8 is a sectional view showing the display panel taken along line VIII-VIII of FIG. 7.

FIG. 9 is an image of part of the display panel obtained by photographing a scanning electron microscope and is a sectional view showing a second basement in which a first hole is formed, etc.

FIG. 10 is a sectional view showing the display panel shown in FIG. 8 and is an explanatory diagram showing the shape of the contact hole.

FIG. 11 is a plan view showing a contact hole and a second surface according to modification 1 of the first embodiment.

FIG. 12 is a sectional view showing a display panel taken along line XII-XII of FIG. 11.

FIG. 13 is a sectional view showing the display panel taken along line XIII-XIII of FIG. 11.

FIG. 14 is a plan view showing a contact hole and a second surface according to modification 2 of the first embodiment.

FIG. 15 is a sectional view showing the display panel taken along line XV-XV of FIG. 14.

FIG. 16 is a sectional view showing part of a display panel according to modification 3 of the first embodiment.

FIG. 17 is a sectional view showing part of a display panel according to modification 4 of the first embodiment.

FIG. 18 is a sectional view showing part of a display panel according to a second embodiment.

FIG. 19 is a plan view showing a contact hole and a second surface according to a third embodiment.

FIG. 20 is a sectional view showing a display panel taken along line XX-XX of FIG. 19.

FIG. 21 is a sectional view showing the display panel taken along line XXI-XXI of FIG. 19.

FIG. 22 is a plan view showing the second surface in a manufacturing process of the display panel according to the third embodiment, and is an explanatory diagram showing a state where a laser beam is applied to a second basement and the second basement is partially changed in quality.

FIG. 23 is a sectional view showing the display panel taken along line XXIII-XXIII of FIG. 22.

FIG. 24 is a plan view showing a contact hole and a second surface according to modification 1 of the third embodiment.

FIG. 25 is a sectional view showing a display panel taken along line XXIV-XXIV of FIG. 24.

FIG. 26 is a plan view showing a contact hole and a second surface according to a fourth embodiment.

FIG. 27 is a sectional view showing a display panel taken along line XXVII-XXVII of FIG. 26.

FIG. 28 is a sectional view showing the display panel in a manufacturing process of a display device according to the fourth embodiment, and is an explanatory diagram showing a state where a plurality of different-sized concavities are formed in a second basement.

FIG. 29 is a sectional view showing the display panel in the manufacturing process subsequently to FIG. 28, and is an explanatory diagram showing a state where a laser beam is applied to the display panel.

FIG. 30 is a sectional view showing part of a display panel according to modification 1 of the fourth embodiment.

FIG. 31 is a sectional view showing the display panel in a manufacturing process of a display device according to modification 1 of the fourth embodiment, and is an explanatory diagram showing a state where the contact hole is formed in the display panel.

FIG. 32 is a plan view showing another example of the structure of the display device.

FIG. 33 is a sectional view showing part of the display device.

FIG. 34 is a plan view showing a first conductive layer and an organic insulating layer shown in FIG. 33.

### DETAILED DESCRIPTION

In general, according to one embodiment, a display device includes a first substrate, a second substrate and a connecting material. The first substrate includes a first basement and a first conductive layer. The second substrate includes a second basement and a second conductive layer. The second basement includes a first surface which is opposed to the first conductive layer and is at a distance from the first conductive layer, a second surface which is located on an opposite side from the first surface, and a first hole which penetrates between the first surface and the second surface. The second conductive layer is provided on the second surface. The connecting material electrically connects the first conductive layer and the second conductive layer via the first hole. On a virtual first plane which passes through the first hole and is parallel to a normal of the first surface, an angle between a first straight line which extends along the normal and a second straight line which connects a first open end on a first surface side of the first hole and a second open end on a second surface side of the first hole is greater than or equal to 45°.

Embodiments will be described hereinafter with reference to the accompanying drawings. The disclosure is merely an example, and proper changes within the spirit of the invention, which are easily conceivable by a skilled person, are included in the scope of the invention as a matter of course. In addition, in some cases, in order to make the description clearer, the widths, thicknesses, shapes, etc., of the respective parts are illustrated schematically in the drawings, rather than as an accurate representation of what is implemented. However, such schematic illustration is merely exemplary, and in no way restricts the interpretation of the invention. In addition, in the specification and drawings, the same elements as those described in connection with preceding drawings are denoted by like reference numbers, and detailed description thereof is omitted unless necessary.

In each embodiment, the display device can be used in various devices such as smartphones, tablet computers, mobile phones, notebook computers and game consoles. The main structure disclosed in each embodiment can be applied to liquid crystal display devices, self-luminous display devices such as organic electroluminescent display devices, electronic paper-type display devices including electrophoretic elements, display devices adopting micro-electromechanical systems (MEMS), electrochromic display devices, etc.

The following embodiments can be applied to various display devices having an inter-basement conduction structure in which a first basement and a second basement are spaced apart from each other, the second basement includes a hole, and a first conductive layer located on the first basement and a second conductive layer located on the second basement are electrically connected to each other via the hole.

### First Embodiment

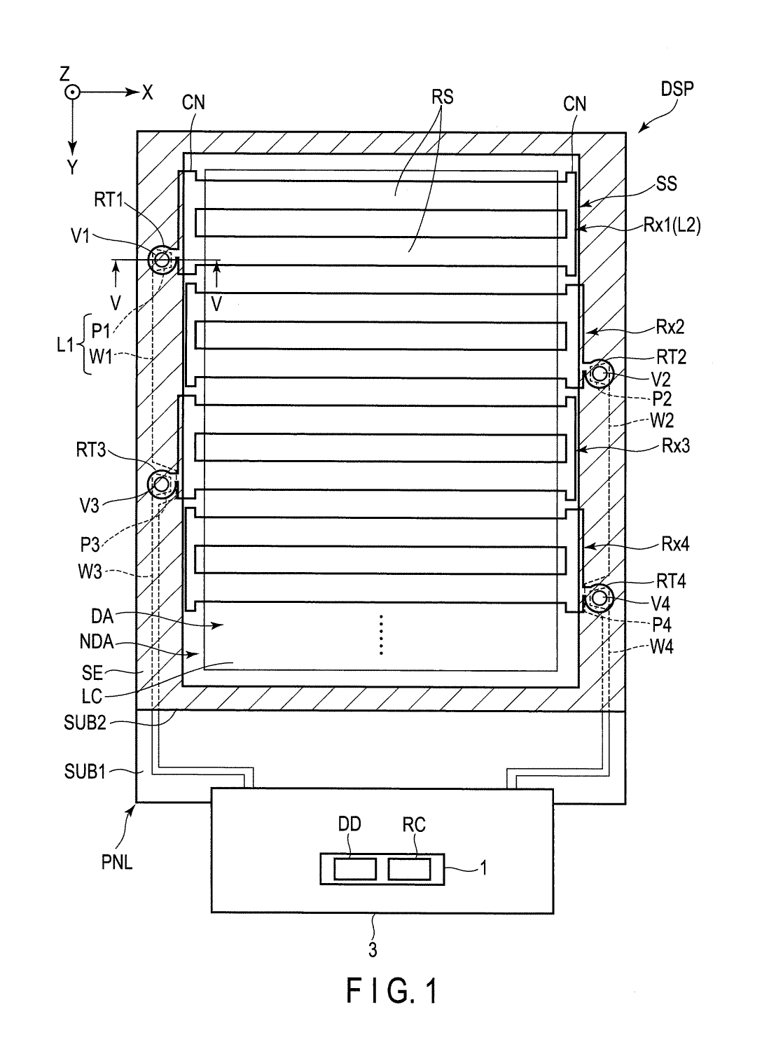

Firstly, the first embodiment will be described. FIG. 1 is a plan view showing an example of a display device DSP of the first embodiment. A first direction X, a second direction Y and a third direction Z orthogonally cross each other but may cross each other at an angle other than an angle of 90°. The first direction X and the second direction Y correspond to directions parallel to the surfaces of substrates constituting the display device DSP, and the third direction Z corresponds to the thickness direction of the display device DSP. As an example of the display device DSP, a liquid crystal display device equipped with a sensor SS will be described below.

As shown in FIG. 1, the display device DSP includes a display panel PNL, an IC chip 1, a circuit board (wiring substrate) 3, a backlight unit BL which will be described later, etc. The display panel PNL is a liquid crystal display panel and includes a first substrate SUB1, a second substrate SUB2, a sealing member SE and a liquid crystal layer LC. The second substrate SUB2 is opposed to the first substrate SUB1 in the third direction Z. The sealing member SE corresponds to a portion shaded by rising diagonal lines in FIG. 1 and bonds the first substrate SUB1 and the second substrate SUB2 to each other. The liquid crystal layer LC is located in a space between the first substrate SUB1 and the second substrate SUB2, inside the sealing member SE.

In the following description, a direction from the first substrate SUB1 to the second substrate SUB2 is referred to as above, and a direction from the second substrate SUB2 to the first substrate SUB1 is referred to as below. Further, a view from the second substrate SUB2 to the first substrate SUB1 is referred to as a planar view.

The display panel PNL includes a display area DA in which an image is displayed, and a non-display area NDA which is provided around the edges of the display area DA. The display area DA is located in a region surrounded by the sealing member SE. The non-display area NDA is a frame-like region surrounding the display area DA and is adjacent to the display area DA. The sealing member SE is located in the non-display area NDA.

The IC chip 1 is mounted on the circuit board 3. The IC chip 1 is not limited to the example shown in FIG. 1 and may be mounted on the first substrate SUB1 extending outward beyond the second substrate SUB2 or may be mounted on an external circuit board connected to the circuit board 3. The IC chip 1 includes a built-in display driver DD which outputs a signal necessary for image display. The display driver DD may include at least part of a signal line drive circuit SD, a scanning line drive circuit GD and a common electrode drive circuit CD which will be described later, for example In the example shown in FIG. 1, the IC chip 1 further includes a built-in detector RC which functions as a touch panel controller, etc. The detector RC may be incorporated into an IC chip other than the IC chip 1.

The sensor SS performs sensing to detect contact or approach of an object to the display device DSP. The sensor SS is a mutual capacitive sensor and can detect contact or approach of an object based on a change in capacitance between a pair of electrodes which are opposed to each other via a dielectric. The sensor SS includes a plurality of sensor drive electrodes Tx and a plurality of detection electrodes Rx (RX1, RX2, RX3, Rx4 . . . ). The sensor drive electrodes Tx will be described later.

Each detection electrode Rx includes main bodies RS which extend across the display area, and connectors CN which connect the main bodies RS to each other. Further, the detection electrodes Rx include terminals RT (RT1, RT2, RT3, RT4 . . . ) connected to the connectors CN, respectively.

The main body RS is formed of a mesh-like collection of metal thin wires and has the shape of a strip. Further, dummy regions are provided between the adjacent main bodies RS, and metal thin wires are arranged in the dummy regions similarly to the main bodies RS. The metal thin wires of the dummy regions are not connected to any wiring lines and are electrically floating.

Further, at least part of the terminal RT overlaps the sealing member SE in a planar view. The terminal RT is located at one edge or the other edge of the non-display area NDA.

The first substrate SUB1 includes pads P (P1, P2, P3, P4 . . . ) and wiring lines W (W1, W2, W3, W4 . . . ). The pad P and the wiring line W are located at one edge or the other edge of the non-display area NDA and overlaps the sealing member SE in a planar view. The pad P overlaps the terminal RT in a planar view. The wiring line W is connected to the pad P and is electrically connected to the detector RC of the IC chip 1 via the circuit board 3.

Contact holes V (V1, V2, V3, V4 . . . ) are formed in locations in which the terminals RT and the pads P are opposed to each other. The contact holes will be described later.

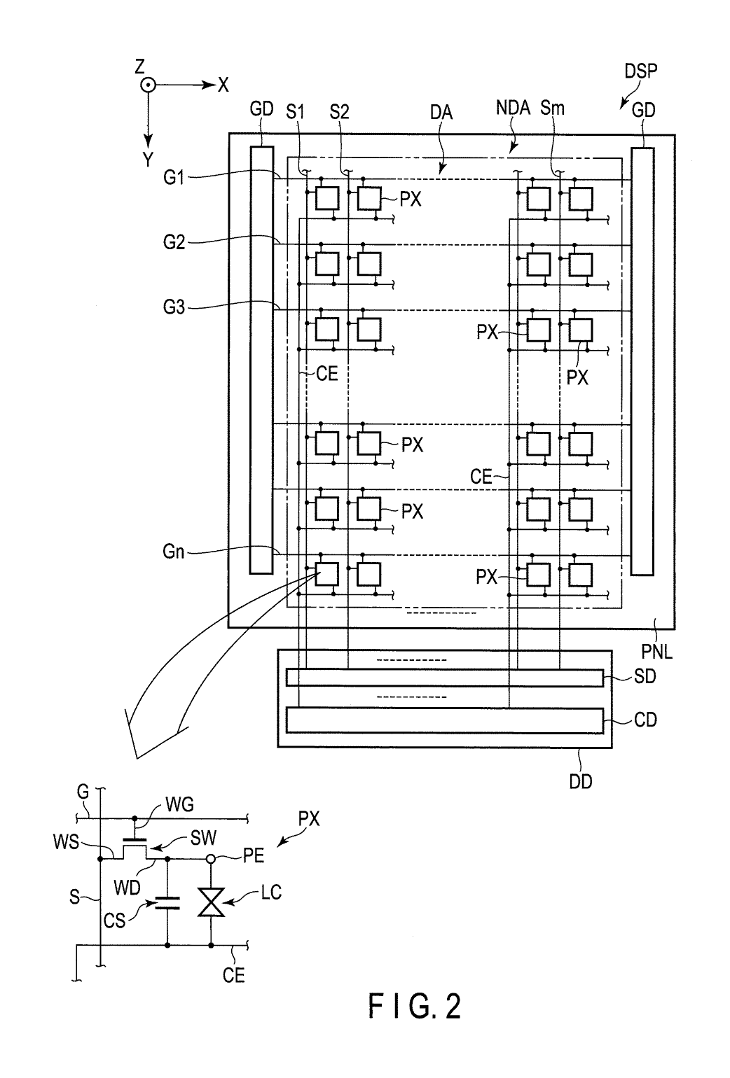

FIG. 2 is a plan view schematically showing the basic structure and the equivalent circuit of the display panel PNL shown in FIG. 1.

As shown in FIG. 2, the display panel PNL includes a plurality of pixels PX in the display area DA. Here, the pixel indicates a minimum unit which can be individually controlled in accordance with a pixel signal, and includes a switching element SW located at the intersection of a scanning line and a signal line which will be described later, for example. The pixels PX are arranged in a matrix in the first direction X and the second direction Y. Further, the display panel PNL includes a plurality of scanning lines G (G1 to Gn), a plurality of signal lines S (S1 to Sm), a common electrode CE, etc., in the display area DA.

The scanning lines G, the signal lines S and the common electrode CE are drawn to the non-display area NDA. In the non-display area NDA, the scanning lines G are connected to the scanning line drive circuit GD, the signal lines S are connected to the signal line drive circuit SD, and the common electrode CE is connected to the common electrode drive circuit CD.

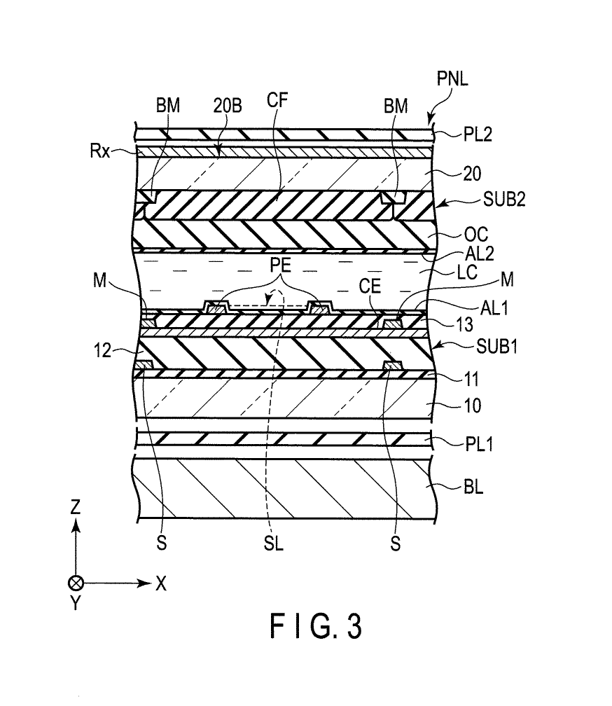

FIG. 3 is a sectional view of the display device DSP in the display area DA taken in the first direction X. In the example shown in FIG. 3, the display panel PNL conforms to a display mode mainly using a lateral electric field along an X-Y plane. The display panel PNL may conform to a display mode using a longitudinal electric field from the first substrate to the second substrate, a display mode using an oblique electric field between the longitudinal electric field and the lateral electric field, or a display mode using a display mode using a combination thereof.

As shown in FIG. 3, the first substrate SUB1 includes a first basement 10, and a first insulating layer 11, the signal lines S, a second insulating layer 12, the common electrode CE, a metal layer M, a third insulating layer 13, pixel electrodes PE, a first alignment film AL1, etc., are stacked in order on the upper surface (third surface) of the first basement 10. In FIG. 3, the switching elements and the scanning lines, and various insulating layers interposed between them are omitted.

The second substrate SUB2 includes a second basement 20, and a light-shielding layer BM, a color filer CF, an overcoat layer OC, a second alignment film AL2, etc., are stacked in order on the lower surface (first surface) of the second basement 20.

Next, an example of the structure of the sensor SS mounted on the display device DSP of the present embodiment will be described.

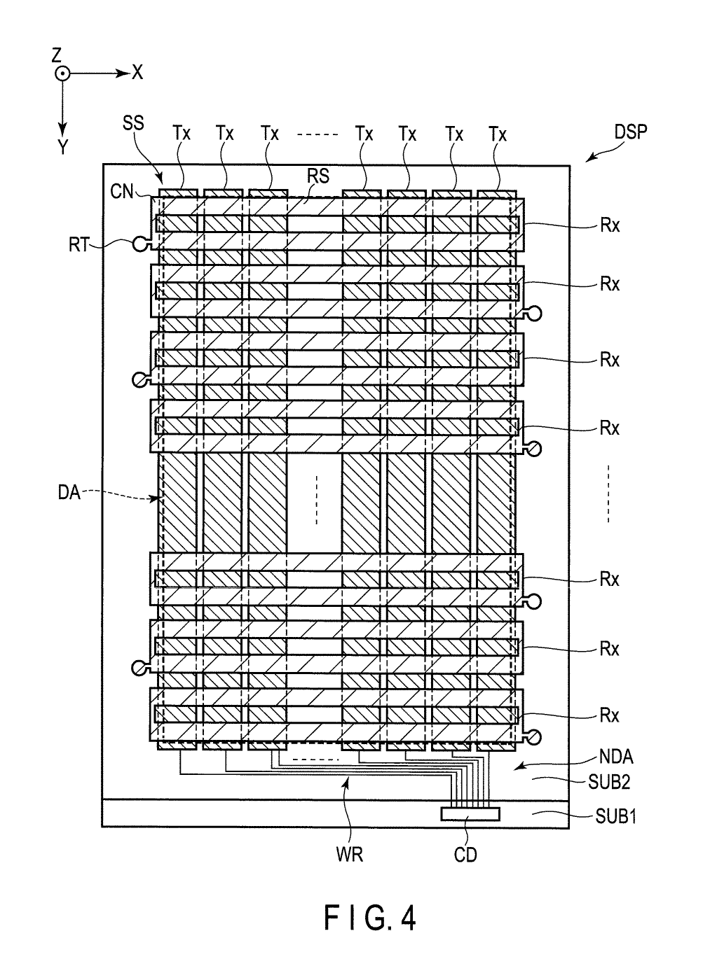

As shown in FIG. 4, the sensor SS includes the sensor drive electrodes Tx and the detection electrodes Rx. In the example shown in FIG. 4, the sensor drive electrodes Tx correspond to portions shaded by falling diagonal lines and are provided on the first substrate SUB1. Further, the detection electrodes Rx correspond to portions shown by rising diagonal lines and are provided on the second substrate SUB2. The sensor drive electrodes Tx and the detection electrodes Rx cross each other on the X-Y plane.

In the example shown in FIG. 4, the sensor drive electrodes Tx have the shape of a strip extending in the second direction Y and are arranged at intervals in the first direction X.

The sensor drive electrodes Tx are electrically connected to the common electrode drive circuit CD via wiring lines WR. In the present embodiment, the sensor drive electrodes Tx are formed of the common electrode CE. That is, in the present embodiment, the common electrode is patterned into strips as shown in FIG. 4. The sensor drive electrode Tx has the function of producing an electric field between the sensor drive electrode Tx and the pixel electrode PE, and the function of detecting the location of an object by producing capacitance between the sensor drive electrode Tx and the detection electrode Rx.

The common electrode drive circuit CD supplies a common signal to the sensor drive electrodes Tx including the common electrode CE in a display period of displaying an image in the display area DA. Further, the common electrode drive circuit CD supplies a sensor drive signal to the sensor drive electrodes Tx in a sensing period (touch period) of performing sensing. As the sensor drive signal is supplied to each sensor drive electrode Tx, each detection electrode Rx outputs a sensor signal necessary for sensing, that is, a signal based on a change in capacitance between the sensor drive electrode Tx and the detection electrode Rx. The sensor signal output from the detection electrode Rx is input to the detector RC shown in FIG. 1. The detector RC reads the sensor signal.

The sensor SS is not limited to the mutual capacitive sensor and may be a self capacitive sensor which detects an object based on a change in the capacitance of the detection electrode Rx itself.

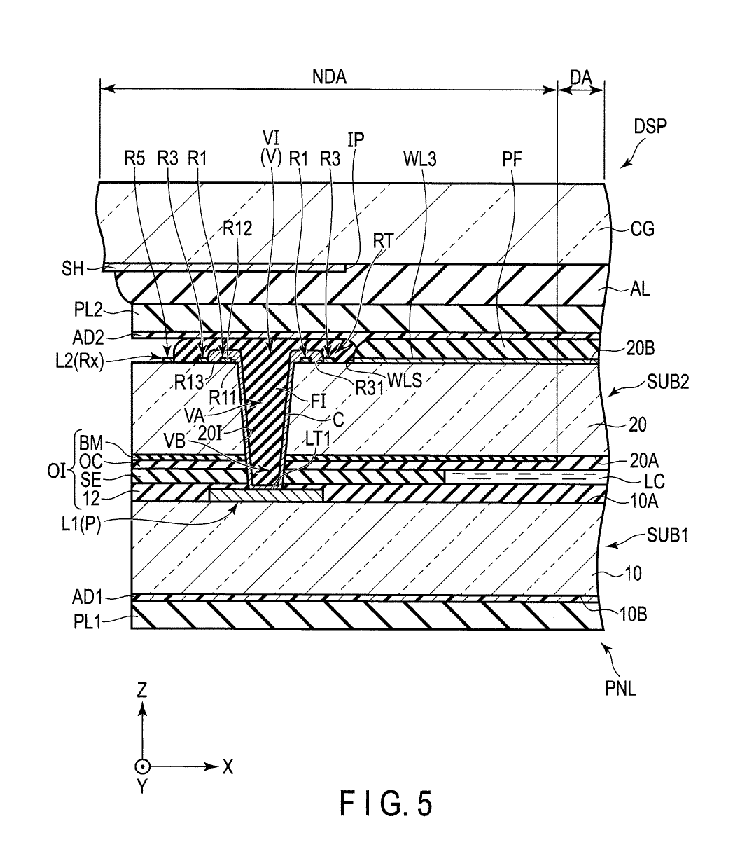

Next, the contact holes V (V1, V2, V3, V4 . . . ) will be described. FIG. 5 is a schematic sectional view of the display device DSP taken along line V-V of FIG. 1.

As shown in FIG. 5, the display device DSP includes the first substrate SUB1, the second substrate SUB2, an organic insulating layer OI, a connecting material C, a first polarizer PL1, a second polarizer PL2 and a cover member CG The first polarizer PL1 is adhered to the first substrate SUB1 by an adhesive layer AD1. The second polarizer PL2 is adhered to the second substrate SUB2 by an adhesive layer AD2.

The first substrate SUB1 includes the first basement 10 and a first conductive layer L1. The first conductive layer L1 includes the pads P (P1, P2, P3, P4 . . . ) and the wiring lines W (W1, W2, W3, W4 . . . ), and is located on a third surface 10A side which is opposed to the second substrate SUB2. The first insulating layer 11 shown in FIG. 3 and other insulating layers and other conductive layers may be provided between the first basement 10 and the pads P and between the first basement 10 and the second insulting layer 12.

The second substrate SUB2 includes the second basement 20 and a second conductive layer L2. A first surface 20A of the second basement 20 is opposed to the first conductive layer L1 and is separated from the first conductive layer L1 in the third direction Z. The second conductive layer L2 includes the detection electrodes Rx, that is, the terminals RT (RT1, RT2, RT3, RT4 . . . ), the connectors CN and the main bodies RS. The second conductive layer L2 is located on a second surface 20B side and is covered with a protection material PF. In other words, the first basement 10, the first conductive layer L1, the second basement 20, the second conductive layer L2 and the protection material PF are arranged in order in the third direction Z.

The organic insulating layer OI is located between the first conductive layer L1 and the second basement 20. In place of the organic insulating layer OI, an inorganic insulating layer or a conductive layer may be provided or an air layer may be provided. Various insulating layers and various conductive layers may be arranged between the second basement 20 and the second conductive layer L2 and on the second conductive layer L2.

For example, the organic insulating layer OI includes the sealing member SE which bonds the first substrate SUB1 and the second substrate SUB2 to each other, the second insulating layer 12 of the first substrate SUB1, the light-shielding layer BM and the overcoat layer OC of the second substrate SUB2, etc. The sealing member SE is located between the second insulating layer 12 and the overcoat layer OC. The liquid crystal layer LC is provided in a space between the first substrate SUB1 and the second substrate SUB2 and is surrounded by the sealing member SE.

The metal layer M, the third insulating layer 13 and the first alignment film AL1 shown in FIG. 3 may be interposed between the second insulating layer 12 and the sealing member SE. The second alignment film AL2 shown in FIG. 3 may be interposed between the overcoat layer OC and the sealing member SE.

The first basement 10 and the second basement 20 are formed of alkali-free glass or transparent resin, for example The protection material PF is formed of an organic insulating material such as acrylic resin, for example. The first conductive layer L1 and the second conductive layer L2 are formed of a metal material such as molybdenum, tungsten, titanium, aluminum, silver, copper or chromium, an alloy of these metal materials, a transparent conductive material such as indium tin oxide (ITO), indium zinc oxide (IZO) or indium gallium oxide (IGO), etc., for example. The first conductive layer L1 and the second conductive layer L2 may have a single layer structure or a multilayer structure.

The second substrate SUB2 has a first hole VA which penetrates the second basement 20 in the non-display area NDA. The first hole VA penetrates between the first surface 20A and the second surface 20B. In the example shown in FIG. 5, the second conductive layer L2 is not provided in a location overlapping the first hole VA.

In addition to the first hole VA, the display device DSP further has a second hole VB which penetrates the organic insulating layer OI. The first hole VA and the second hole VB communicate with each other and constitute the contact hole V. Unlike the present embodiment, the contact hole V may further have a hole which penetrates the first conductive layer L1 and a concavity which is formed in the first basement 10.

The second hole VB includes a hole penetrating the second insulating layer 12, a hole penetrating the sealing member SE, a hole penetrating the light-shielding layer BM and the overcoat layer OC, etc. The first conductive layer L1 has an upper surface LT1 which is not covered with the organic insulating layer OI in the second hole VB.

The second hole VB is located directly below the first hole VA. The contact hole V can be formed by laser beam application from above the second substrate SUB2 and etching. The organic insulating layer OI in which the second hole VB is formed may be formed of a material which can be easily etched as compared to that of the second basement 20 in which the first hole VA is formed.

The connecting material C is provided in the contact hole V. The connecting material C, and layers in which the contact hole V is formed, that is, the first substrate SUB1, the second substrate SUB2 and the organic insulating layer OI constitute an inter-substrate conduction structure according to the present embodiment. The connecting material C includes a metal material such as silver and should preferably include a mixture of fine particles thereof which have a particle diameter of several nanometers to several tens of nanometers and a solvent, for example.

In the connecting material C adhered to the surface of the contact hole V, the solvent is evaporated and substantially only the metal material is adhered.

The connecting material C electrically connects the first conductive layer L1 and the second conductive layer L2 (the terminal RT) provided on the different substrates via the contact hole V. The connecting material C is located inside and outside the contact hole V. The connecting material C covers an inner peripheral surface 20I of the second basement 20 in the first hole VA, an inner peripheral surface of the organic insulating layer OI in the second hole VB, etc. Further, the connecting material C is located above the second surface 20B.

In the example shown in FIG. 5, with regard to the relationship between the connecting material C and the first conductive layer L1, the connecting material C is in contact with the upper surface LT1 of the pad P in the second hole VB. With regard to the relationship between the connecting material C and the second conductive layer L2, the connecting material C is in contact with an inner peripheral surface R11, an upper surface R12 and an outer peripheral surface R13 of a first projection R1, and an inner peripheral surface R31 of a third projection R3 which will be described later.

In the example shown in FIG. 5, the connecting material C is in contact with the inner peripheral surface of the first hole VA and the inner peripheral surface of the second hole VB, but the central portions of the holes are not filled with the contact member C. More specifically, the connecting material only covers the inner peripheries as a thin film, and the film thickness is small.

To fill the hollow in the hole, the hole is filled with a filling material FI. The filling material FI is formed of the same material as that of the protection material PF, for example. The hole may be completely filled with the connecting material C instead.

The connecting material C is continuously formed between the first conductive layer L1 and the second conductive layer L2. Accordingly, the second conductive layer L2 is electrically connected to the circuit board 3 via the connecting material C and the first conductive layer L1. Therefore, a control circuit which writes a signal to the second conductive layer L2 or reads a signal output from the second conductive layer L2 can be connected to the second conductive layer L2 via the circuit board 3. Consequently, a separate circuit board for the second substrate SUB2 will not be required for connecting the second conductive layer L2 and the control circuit.

The cover member CG is flat, extends over the display area DA and the non-display area NDA, and covers the entire surface of the display panel PNL. A light-shielding layer SH is formed on a surface of the cover member CG which is opposed to the display panel PNL. The light-shielding layer SH is provided in the non-display area NDA. The light-shielding layer SH covers the contact hole V, the connecting material C, etc.

The cover member CG is adhered to the second polarizer PL2 by an adhesive layer AL. For example, the adhesive layer AL is formed of optically clear resin (OCR). The adhesive layer AL has a substantially uniform thickness throughout the entire region.

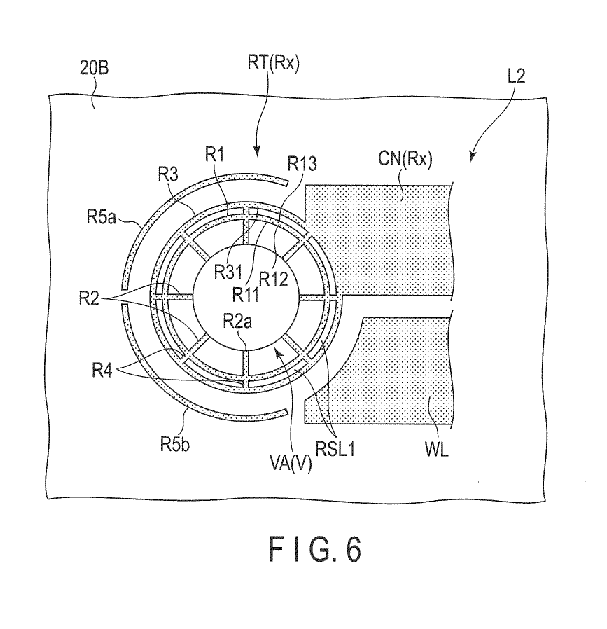

Next, the second conductive layer L2 (the terminal RT) of the present embodiment will be described. FIG. 6 is a plan view of the terminal RT (RT1, RT2, RT3, RT4 . . . ) of the present embodiment when viewed from the cover member CG side.

As shown in FIG. 6, the terminal RT has a first projection R1, a second projection R2, a third projection R3, a fourth projection R4 and a fifth projection R5 which are concentric with a center the contact hole. These projections R1 to R5 function as flow stoppers which stop the outflows of the connecting material C and the filling material FI which are injected into the contact hole V.

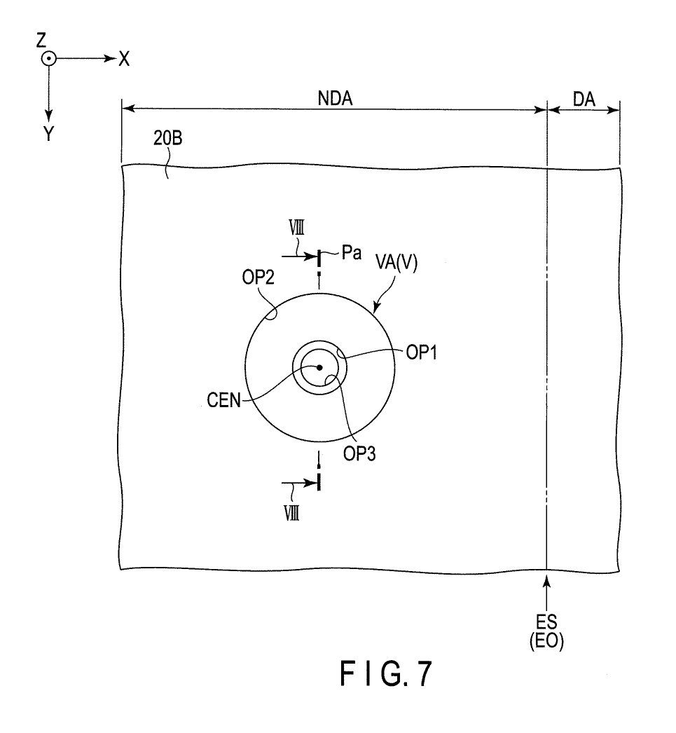

As shown in FIG. 7, the contact hole V has a second open end OP2 and a third open end OP3. The second open end OP2 is located on the second surface 20B side of the contact hole V (the first hole VA). The third open end OP3 is located on the first basement 10 side of the contact hole V. With regard to the first hole VA of the contact hole V, the first hole VA has the second open end OP2 and a first open end OP1. The first open end OP1 is located on the first surface 20A side of the first hole VA. As shown in FIG. 7, the first open end OP1, the second open end OP2 and the third open end OP3 are perfect circles and concentric circles having a same center CEN.

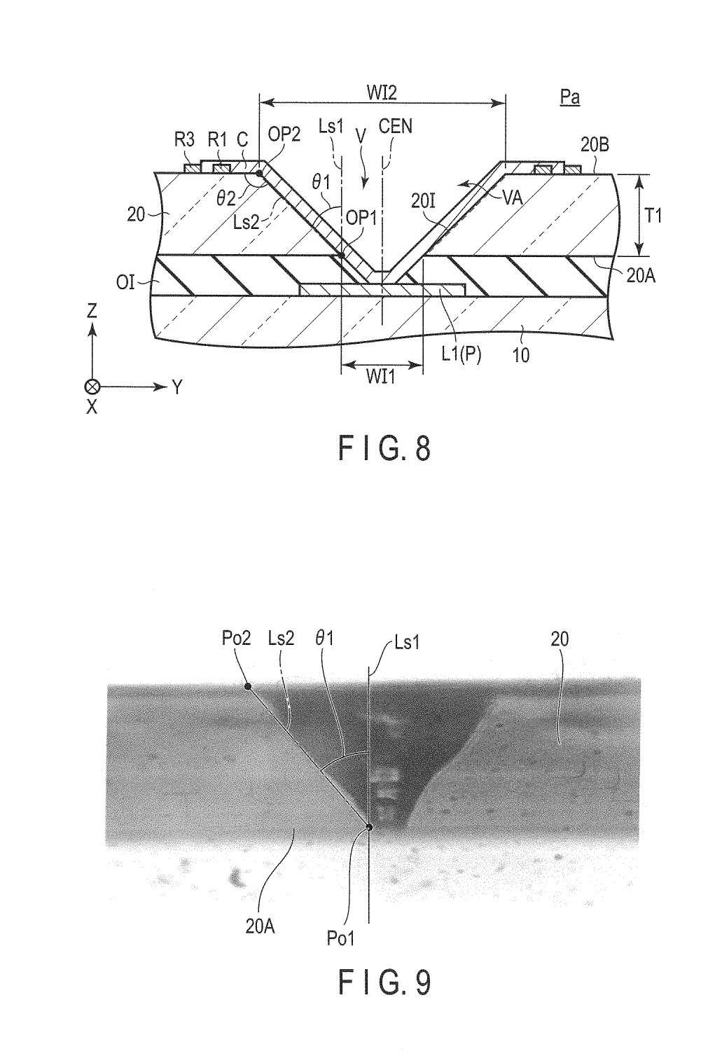

FIG. 8 is a sectional view showing the display panel taken along line VIII-VIII of FIG. 7. FIG. 8 shows a cross-section on a virtual first plane Pa which passes through the contact hole V (the first hole VA). In the present embodiment, the first plane Pa passes through the center CEN of the contact hole V and is parallel to an edge ES opposed to the contact hole V among the edges EO of the display area DA. In other words, the first plane Pa is parallel to a Y-Z plane defined by the second direction Y and the third direction Z (directions parallel to the normal of the first surface 20A).

As shown in FIG. 8, an angle θ1 formed between a first straight line Ls1 and a second straight line Ls2 on the virtual first plane Pa, which passes through the first hole VA and is parallel to the normal of the first surface 20A, is greater than or equal to 45°. The angle θ1 is greater than or equal to 45° and less than 90° (45°≤θ1<90°). Here, the first straight line Ls1 extends along the normal. The second straight line Ls2 connects the first open end OP1 and the second open end OP2 of the first hole VA. In the present embodiment, on the first plane Pa, angles formed between all tangent lines of the inner peripheral surface 20I of the second basement 20 in the first hole VA and the first straight line Ls1 are greater than or equal to 45°.

Further, on the first plane Pa, an angle θ2 formed between the second surface 20B and the second straight line Ls2 on the inside of the second basement 20 is greater than or equal to 135°. The angle θ2 is greater than or equal to 135° and less than 180° (135°≤θ2<180°). Here, the angles θ1 and θ2 in the region on the left side from the center CEN have been described as a representative example. In the present embodiment, the same is also applied to the angles θ1 and θ2 in the region on the right side from the center CEN.

Next, the width of the first hole VA and the thickness of the second basement 20 will be described. On the first plane Pa, the width of the first open end OP1 of the first hole VA is assumed to be a first width WI1, the width of the second open end OP2 of the first hole VA is assumed to be a second width WI2, and the thickness of the second basement 20 in the third direction Z is assumed to be a first thickness T1. The present embodiment satisfies (WI2−WI1)/2≥T1. Further, the slopes of the inner peripheral surface 20I are symmetrical to the center CEN in the present embodiment.

Here, the inventors, etc., implemented the display panel PNL of the present embodiment and investigated the angle θ1. FIG. 9 is an image of part of the display panel PNL obtained by photographing a scanning electron microscope and is a sectional view showing the second basement 20 in which the first hole VA is formed, etc.

As a result of the investigation of the angle θ1 based on FIG. 9, the angle θ1 was greater than or equal to 45° (45°≤θ1).

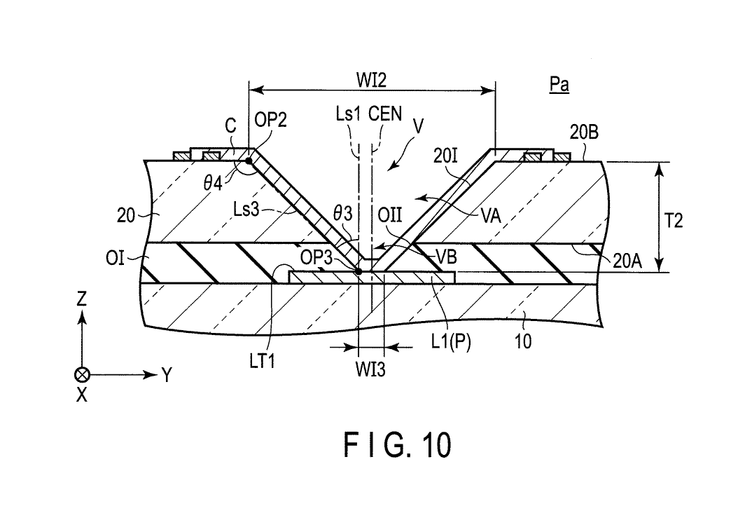

Next, the entire contact hole V including the first hole VA and the second hole VB will be described. FIG. 10 is a sectional view showing the display panel PNL shown in FIG. 8 and is an explanatory diagram showing the shape of the contact hole V.

A shown in FIG. 10, on the first plane Pa, an angle θ3 formed between the first straight line Ls1 and a third straight line Ls3 is greater than or equal to 45°. Note that the angle θ3 is greater than or equal to 45° and less than 90° (45°≤θ3<90°). Here, the third straight line Ls3 connects the third open end OP3 of the contact hole V on the first basement 10 side and the second open end OP2. In the present embodiment, on the first plane Pa, angles formed between all tangent lines of the inner peripheral surface 20I of the second basement 20 and the inner peripheral surface OII of the organic insulating layer OI in the contact hole V and the first straight line Ls1 are greater than or equal to 45°.

Further, on the first plane Pa, an angle θ4 formed between the second surface 20B and the third straight line Ls3 on the inside of the second basement 20 is greater than or equal to 135°. The angle θ4 is greater than or equal to 135° and less than 180° (135°≤4<180°). Here, the angles θ3 and θ4 in the region on the left side of the center CEN have been described as a representative example. In the present embodiment, the same is also applied to the angles θ3 and θ4 in the region on the right side of the center CEN.

Next, the width of the contact hole V and the sum of the thickness of the second basement 20 and the thickness of the organic insulating layer OI will be described. On the first plane Pa, the width of the contact hole V on the first basement 10 side is assumed to be a third width WI3, and the sum of the thickness of the second basement 20 and the thickness of the organic insulating layer OI in the third direction Z is assumed to be a second thickness T2. Here, the second thickness T2 is the height of the contact hole V in the third direction Z and the distance from the upper surface LT1 of the pad P to the second surface 20B in the third direction Z. The width of the second open end OP2 of the contact hole V is the second width WI2. The present embodiment satisfies (WI2−WI3)/2≥T2. Further, the slopes of the inner peripheral surfaces 20I and OII are symmetrical to the center CEN in the present embodiment.

According to the display device DSP of the first embodiment which is structured as described above, in the contact hole, the angle θ1 is greater than or equal to 45°, and the inner peripheral surface 20I of the second basement 20 has a gentle slope. If the angle θ1 is greater than or equal to 45° (45°≤θ1), as compared to a case where the angle is less than 45° (45°>θ1), the connecting material C can be excellently retained on the inner peripheral surface 20I. Accordingly, the first conductive layer L1 and the second conductive layer L2 can be excellently connected to each other by the connecting material C.

From the above, the display device DSP having a highly-reliable inter-substrate connector can be obtained.

### Modification 1 of First Embodiment

Next, modification 1 of the first embodiment will be described.

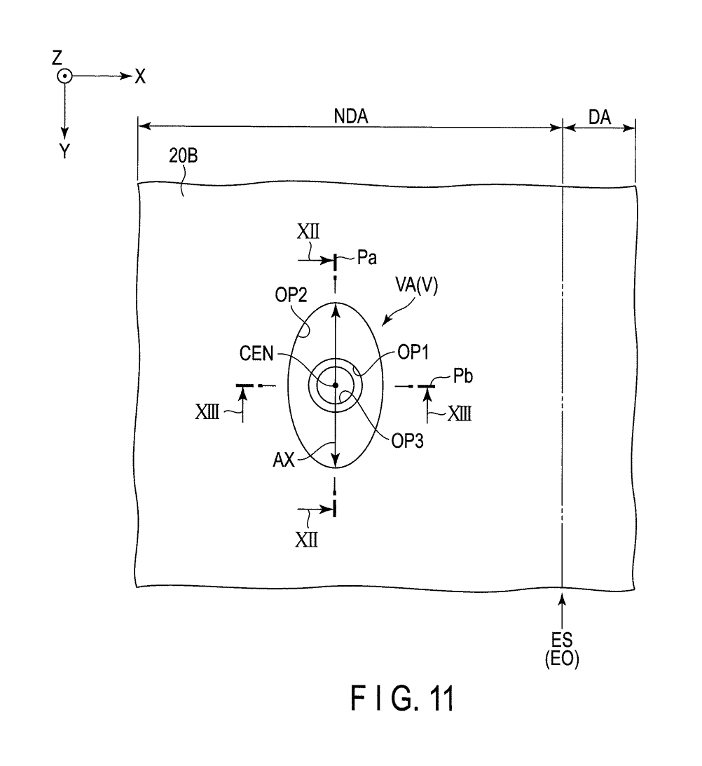

As shown in FIG. 11, modification 1 differs from the first embodiment in the shape of the second open end OP2. In a planar view, the second open end OP2 is an ellipse and has a major axis AX. The major axis AX is parallel to the edge ES of the display area DA. As compared to a case where the major axis AX is parallel to the first direction X, the non-display area NDA of the display panel PNL, especially, the width of sides thereof at edges at which the contact holes V are provided can be reduced. Consequently, the frame can be narrowed.

The major axis AX may not be parallel to the second direction Y and may be parallel to the first direction X, for example.

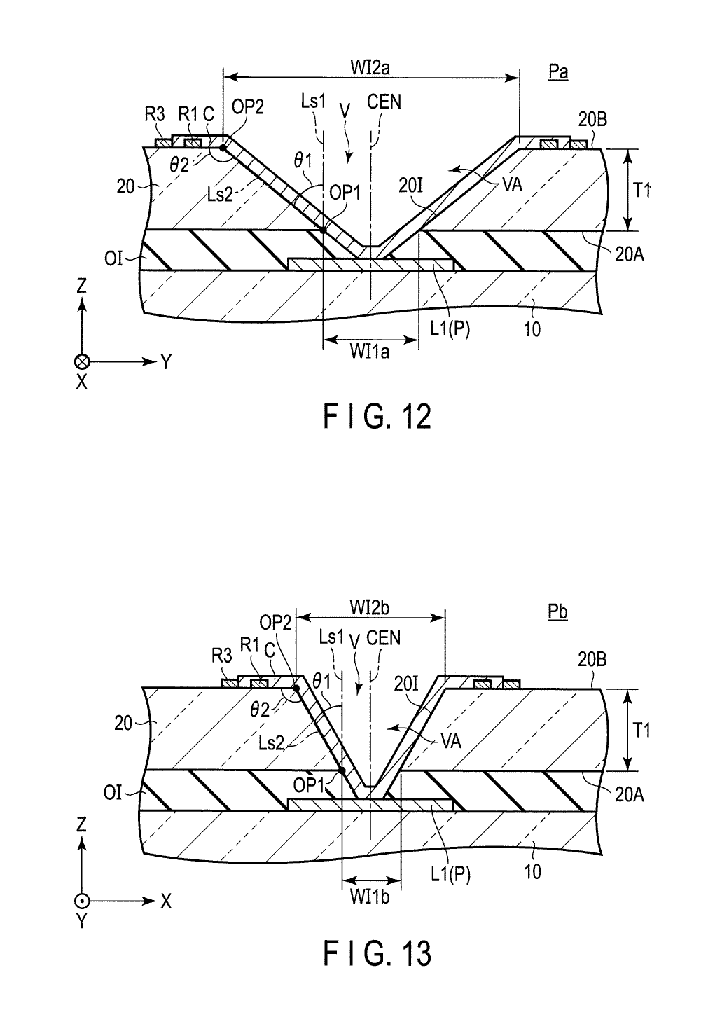

As shown in FIG. 12, the angle θ1 is greater than or equal to 45° on the virtual first plane Pa which passes through the first hole VA and is parallel to the normal of the first surface 20A. In modification 1, on the first plane Pa, angles formed between all tangent lines of the inner peripheral surface 20I of the second basement 20 in the first hole VA and the first straight line Ls1 are greater than or equal to 45°. Further, the angle θ2 is greater than or equal to 135° on the first plane Pa. In the present embodiment, the angles θ1 and θ2 in the region on the left side of the center CEN are the same as the angles θ1 and θ2 in the region on the right side of the center CEN.

On the first plane Pa, the width of the first open end OP1 of the first hole VA is assumed to be a first width WI1a, and the width of the second open end OP2 of the first hole VA is assumed to be a second width WI2a. Modification 1 satisfies (WI2a−WI1a)/2≥T1.

As shown in FIG. 13, on the other hand, the angle θ1 is less than 45° on a virtual second plane Pb which passes through the first hole VA, is orthogonal to the first plane Pa, and is parallel to the normal of the first surface 20A. In modification 1, on the second plane Pb, angles formed between all tangent lines of the inner peripheral surface 20I of the second basement 20 in the first hole VA and the first straight line Ls1 are less than 45°. Further, the angle θ2 is less than 135° on the second plane Pb.

On the second plane Pb, the width of the first open end OP1 of the first hole VA is assumed to be a first width WI1b, and the width of the second open end OP2 of the first hole VA is assumed to be a second width WI2b. Modification 1 satisfies (WI2b−WI1b)/2<T1.

In modification 1 also, the first plane Pa satisfies 45°≤θ1. Therefore, the same effect as that produced from the first embodiment can also be produced from modification 1.

### Modification 2 of First Embodiment

Next, modification 2 of the first embodiment will be described.

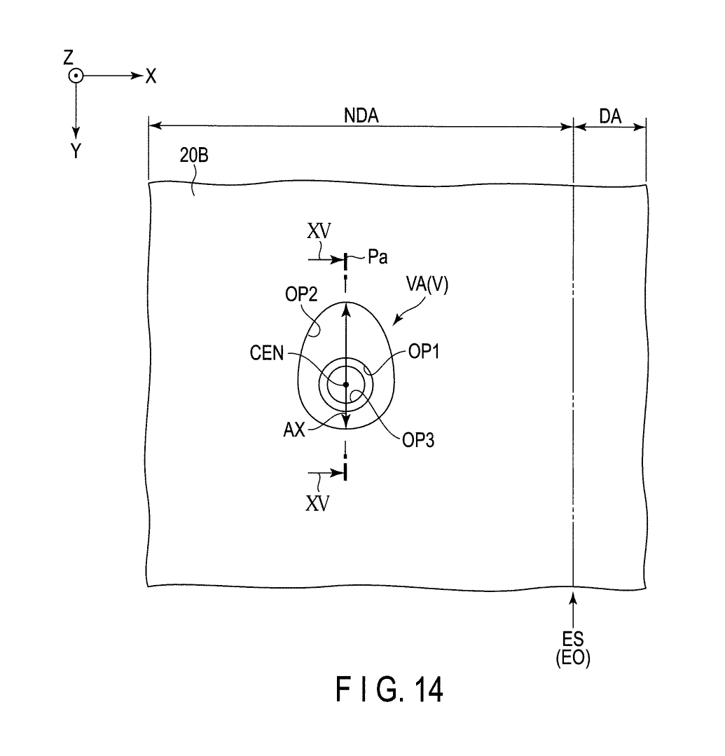

As shown in FIG. 14, modification 2 differs from the first embodiment in the shape of the second open end OP2. The second open end OP2 has the major axis AX parallel to the edge ES. On the first plane Pa, the distance between the first open end OP1 to the second open end OP2 in the second direction Y is not consistent.

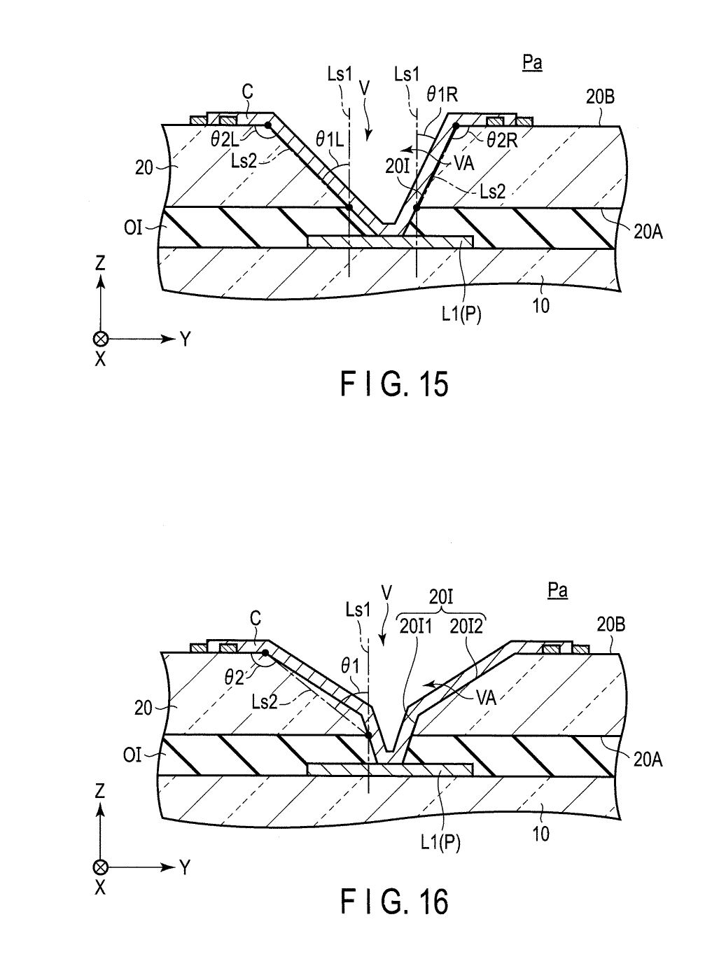

As shown in FIG. 15, the angle θ1 on the left side is assumed to be an angle θ1L, and the angle θ1 on the right side is assumed to be an angle θ1R. On the first plane Pa, the angle θ1L is greater than or equal to 45°, and the angle θ1R is less than 45°. Further, the angle θ2 on the left side is assumed to be an angle θ2L, and the angle θ2 on the right side is assumed to be an angle θ2R. On the first plane Pa, the angle θ2L is greater than or equal to 135°, and the angle θ2R is less than 135°.

In modification 2 also, the first plane Pa satisfies 45°≤θ1L. Therefore, the same effect as that produced from the first embodiment can also be produced from modification 2.

### Modification 3 of First Embodiment

Next, modification 3 of the first embodiment will be described.

As shown in FIG. 16, modification 3 differs from the first embodiment in terms of the inner peripheral surface 20I of the second basement 20 in the first hole VA. On the first plane Pa, the inner peripheral surface 20I projects to the second surface 20B side from the second straight line Ls2. In modification 3, the entire inner peripheral surface 20I projects to the second surface 20B side from the second straight line Ls2.

The inner peripheral surface 20I has a first inner peripheral surface 20I1 and a second inner peripheral surface 20I2 which are continuous with each other. The first inner peripheral surface 20I1 is provided on the first surface 20A side. The second inner peripheral surface 20I2 is provided on the second surface 20B side from the first inner peripheral surface 20I1 and has a slope gentler than that of the first inner peripheral surface 20I1. Modification 3 also satisfies 45°≤θ1 and 135°≤θ2.

In modification 3 also, the first plane Pa satisfies 45°≤θ1. Therefore, the same effect as that produced from the first embodiment can also be produced from modification 3.

The inner peripheral surface 20I projects to the second surface 20B side from the second straight line Ls2. As compared to a case where the inner peripheral surface 20I is recessed toward the first surface 20A side from the second straight line Ls2, the adhesiveness of the connecting material C to the inner peripheral surface 20I can be improved.

Between the first inner peripheral surface 20I1 and the second inner peripheral surface 20I2, the second inner peripheral surface 20I2 having a gentler slope is located on the second surface 20B side. As compared to a case where the slope of the first inner peripheral surface 20I1 is gentler than the slope of the second inner peripheral surface 20I2, the adhesiveness of the connecting material C to the inner peripheral surface 20I can be improved. In particular, the connecting material C tends to be gathered to the first substrate SUB1 side by gravity, immediately after the connecting material C is injected. When a gentle slope is formed on the second substrate SUB2 side as in modification, the adhesiveness of the connecting material C can be improved, especially, on the second substrate SUB2 side.

### Modification 4 of First Embodiment

Next, modification 4 of the first embodiment will be described.

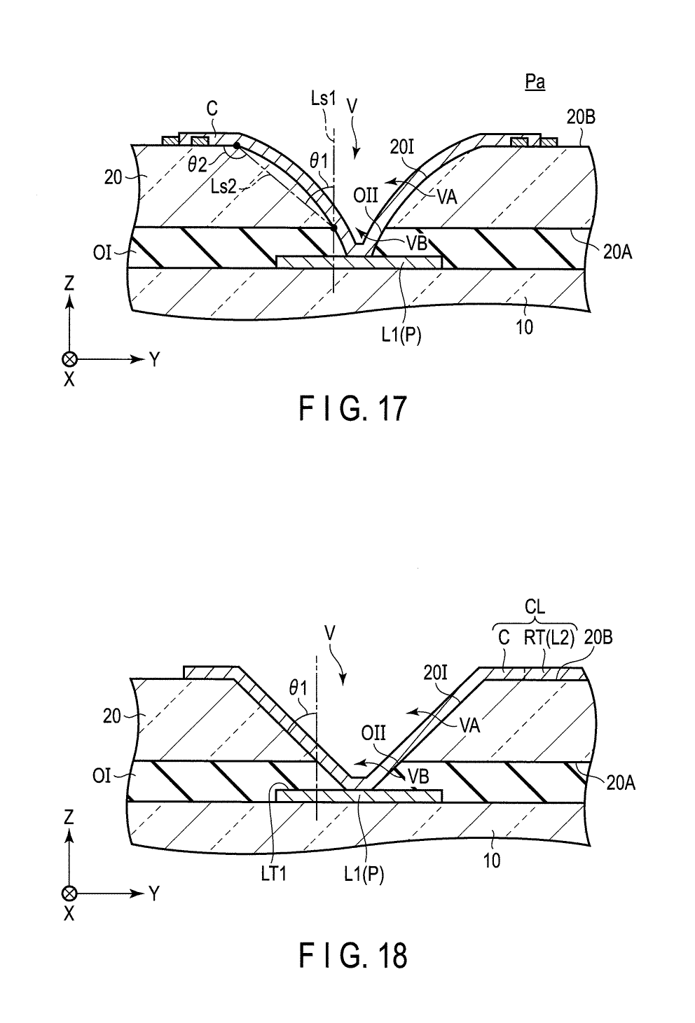

As shown in FIG. 17, modification 4 differs from the first embodiment in terms of the inner peripheral surface 20I of the second basement 20 in the first hole VA. On the first plane Pa, the inner peripheral surface 20I is a curved surface which is convex to the second surface 20B side, and projects to the second surface 20B side from the second straight line Ls2. Modification 4 also satisfies 45°≤θ1 and 135°≤θ2.

The same effect as that produced from the first embodiment can also be produced from modification 4. With regard to the slope of the inner peripheral surface 20I, the slope on the second surface 20B side is gentler than the slope on the first surface 20A side. Therefore, in modification 4 also, the adhesiveness of the connecting material C can be improved, especially, on the second substrate SUB2 side.

### Second Embodiment

Next, the second embodiment will be described. The display device DSP of the second embodiment differs from that of the first embodiment in that the second conductive layer L2 and the connecting material C are integrally formed with each other.

As shown in FIG. 18, the second conductive layer L2 and the connecting material C are formed of the same material as each other and are integrally formed with each other, and constitute a conductive layer CL. The conductive layer CL is formed of metal. The conductive layer CL is formed above the second surface 20B and contacts the first conductive layer L1 via the contact hole V. In the present embodiment, the conductive layer CL is in contact with the second surface 20B, the inner peripheral surface 20I, the inner peripheral surface OII and the upper surface LT1. The conductive layer CL functions as the main body RS in the display area DA, functions as the terminal RT in the non-display area NDA and functions as the connecting material C inside the contact hole V.

To form the conductive layer CL, a metal layer is formed on the second surface 20B and inside the contact hole V, and a resist layer is then formed on the metal layer. A resist mask is then formed by using the resist layer. After that, the metal layer is patterned through the resist mask, and the resist mask is removed.

The display device DSP of the second embodiment which is structured as described above also satisfies 45°≤θ1. The same effect as that produced from the first embodiment can also be produced from the second embodiment.

Further, since the display device DSP has the angle θ1, the conductive layer CL can be formed by the same process as the process of forming the scanning lines G and the signal lines S. As compared to the first embodiment, the concern about the contact resistance between the second conductive layer L2 and the connecting material C can be removed.

The conductive layer CL may have an antireflective layer on the most distant side from the second surface 20B, and the antireflective layer may form the frontmost surface of the conductive layer CL. The reflection of external light in the conductive layer CL can be reduced.

In addition, since the second conductive layer L2 and the connecting material C can be concurrently formed, the manufacturing processes can be reduced in the present embodiment. Accordingly, the manufacturing time and the manufacturing cost can be reduced.

### Third Embodiment

Next, the third embodiment will be described. The display device DSP of the third embodiment differs from that of the first embodiment in that the inner peripheral surface 20I of the second basement 20 in the first hole VA has steps.

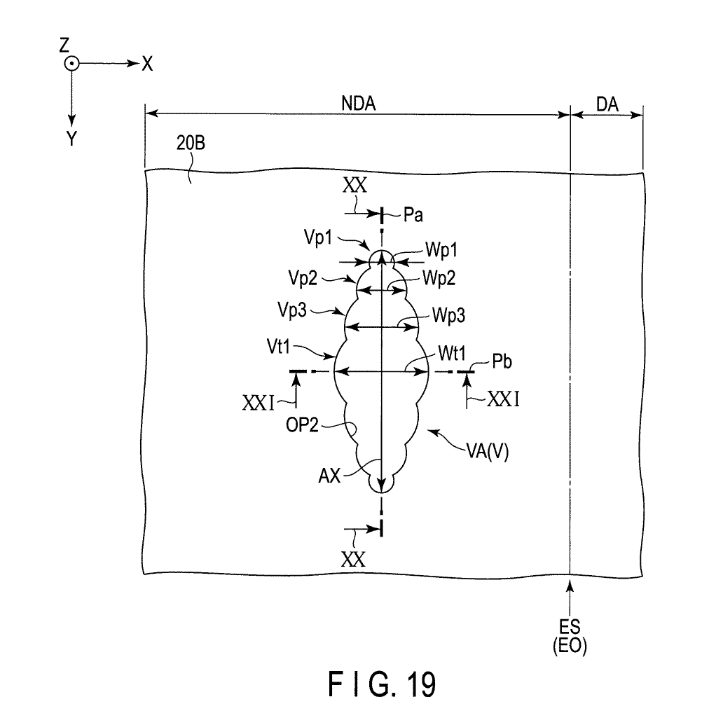

As shown in FIG. 19, the contact hole V (the first hole VA) has the major axis AX in a planar view. In this example, the major axis AX extends along the edge ES of the display area DA. The contact hole V has a first hole portion Vt1, first concavity portions Vp1, second concavity portions Vp2 and third concavity portions Vp3. The first hole portion Vt1, the first concavity portions Vp1, the second concavity portions Vp2 and the third concavity portions Vp3 are arranged along the major axis AX and are continuous with each other.

In the direction (the first direction X) orthogonal to the major axis AX in a planar view, the first hole portion Vt1 has a largest width Wt1, the third concavity portions Vp3 have a width Wp3 smaller than the width of the first hole portion Vt1, the second concavity portions Vp2 have a width Wp2 smaller than the width of the third concavity portions Vp3, and the first concavity portions Vp1 have a smallest width Wp1. In the present embodiment, in the first direction X, the width Wt1 is the largest width of the first hole portion Vt1, the width Wp3 is the largest width of the third concavity portion Vp3, the width Wp2 is the largest width of the second concavity portion Vp2, and the width Wp1 is the largest width of the first concavity portion Vp1. For example, the width Wt1 is larger than the width Wp1.

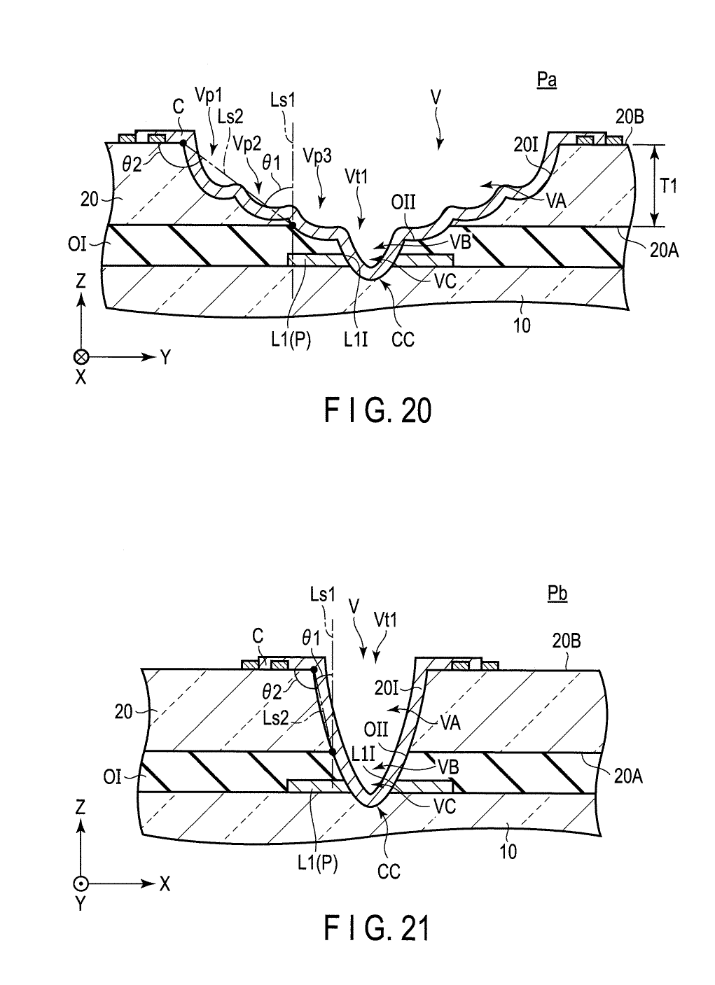

As shown in FIG. 20, the contact hole V further has a third hole VC which penetrates the first conductive layer L1, and a concavity CC which is formed in the first basement 10. The first hole VA is formed of the first hole portion Vt1, the first concavity portions Vp1, the second concavity portions Vp2 and the third concavity portions Vp3. The second hole VB is formed of the first hole portion Vt1 and the third concavity portions Vp3. The third hole VC and the concavity CC are formed in the first hole portion Vt1.

The angle θ1 is greater than or equal to 45° on the virtual first plane Pa which passes through the first hole VA and is parallel to the normal of the first surface 20A. Further, the angle θ2 is greater than or equal to 135° on the first plane Pa.

On the first plane Pa, the inner peripheral surface 20I of the second basement 20 in the first hole VA has steps. On the first plane Pa of the present embodiment, the inner peripheral surface 20I of the second basement 20 and the inner peripheral surface OII of the organic insulating layer OI in the contact hole V have steps. The steps are formed in locations of connection between the first hole portion Vt1 and the third concavity portions Vp3, in locations of connection between the third concavity portions Vp3 and the second concavity portions Vp2, and in locations of connection between the second concavity portions Vp2 and the first concavity portions Vp1. Although the inner peripheral surfaces 20I and OII have steps, the angle θ1 is greater than or equal to 45° (45°≤θ1). Therefore, the connecting material C can be excellently retained on the inner peripheral surfaces 20I and OII.

As shown in FIG. 21, on the other hand, the angle θ1 is less than 45° and the angle θ2 is less than 135° on the virtual second plane Pb which passes through the first hole VA, is orthogonal to the first plane Pa, and is parallel to the normal of the first surface 20A.

On the second plane Pb, the inner peripheral surface 20I of the second basement 20 and the inner peripheral surface OII of the organic insulating layer OI do not have steps.

Next, a manufacturing method of the display device DSP of the present embodiment will be described. Here, a method of forming the contact hole V will be described.

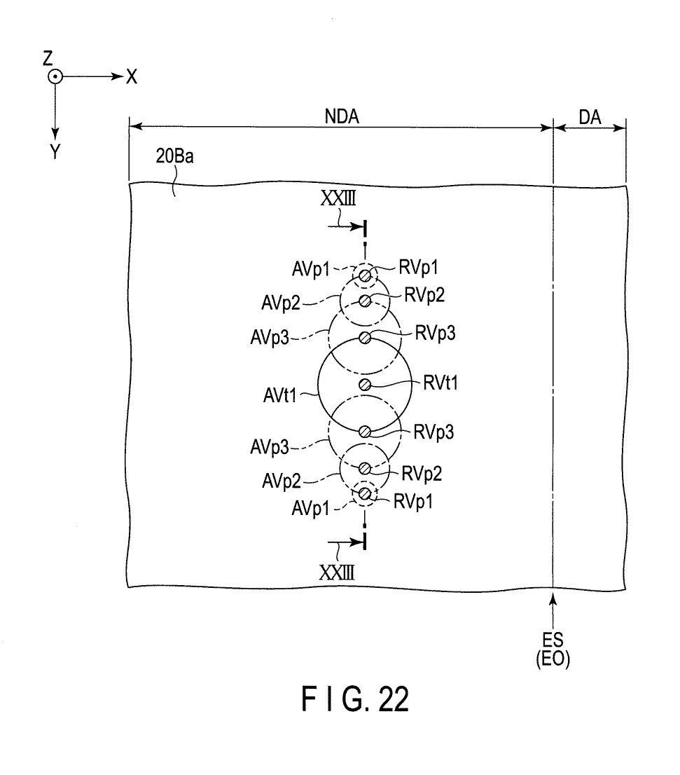

As shown in FIG. 22, before the second basement 20 is etched, the second basement 20 has a second surface 20Ba instead of the second surface 20B. To form the contact hole V, firstly, a laser beam is applied to a plurality of irradiation regions of the second basement 20 from above the second surface 20Ba. The irradiation regions include an irradiation region RVt1 corresponding to a region AVt1 for forming the first hole portion Vt1, irradiation regions RVp3 corresponding to regions AVp3 for forming the third concavity portions Vp3, irradiation regions RVp2 corresponding to regions AVp2 for forming the second concavity portions Vp2, and irradiation regions RVp1 corresponding to regions AVp1 for forming the first second portions Vp1. For example, each irradiation region is located at the center of each region for forming a corresponding hole portion or concavity portion. The laser beam is a pulsed laser beam and has a pulse width of about several femtoseconds to several hundreds of femtoseconds.

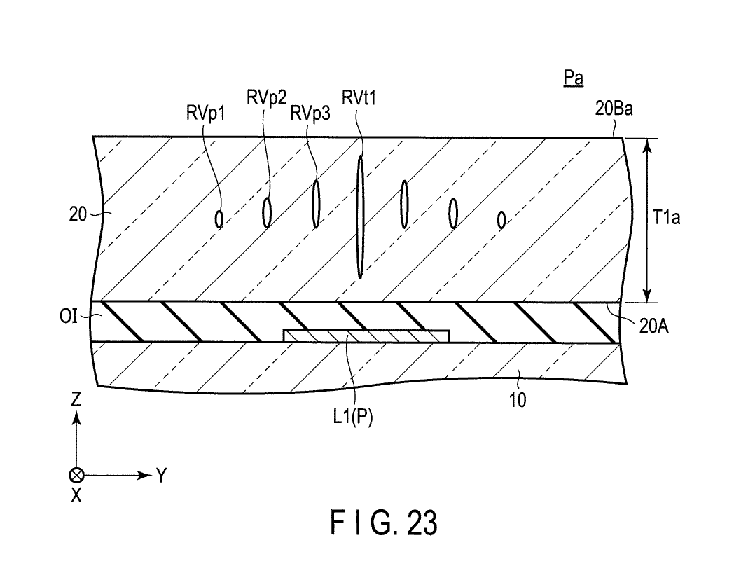

As shown in FIG. 23, before the second basement 20 is etched, the second basement 20 has a thickness T1a greater than the first thickness T1 in the third direction Z. In the third direction Z, the irradiation regions RVp1 are the narrowest region, the irradiation regions RVp2 are broader than the irradiation regions RVp1, the irradiation regions RVp3 are broader than the irradiation regions RVp2, and the irradiation region RVt1 is the broadest region. The irradiation region corresponds to a region for changing the second basement 20 in quality.

As described above, after the laser beam is applied to the second basement 20, the second basement 20 is etched. As a result, the second basement 20 having the first thickness T1 is obtained. In the second basement 20, the etching rate of a region which is changed in quality is higher than the etching rate of a region which is not changed in quality. Therefore, the etching of the regions AVt1, AVp3, AVp2 and AVp1 is promoted in the second basement 20. Further, the etching of the region AVt1 is promoted most. Consequently, the contact hole V is formed.

The display device DSP of the third embodiment which is structured as described above also satisfies 45°≤θ1 and 135°≤θ2. The same effect as that produced from the first embodiment can also be produced from the third embodiment.

The first hole VA (the contact hole V) is not formed only by laser beam application but is formed by laser beam application and etching. Therefore, cracks originating from the first hole VA can be prevented in the second basement 20.

Etching is performed when both substrates SUB1 and SUB2 are still in a large size. The large size here means a state of the substrates before the substrates are divided into a plurality of display panel pieces. In the present embodiment, the contact hole is formed in accordance with the etching process of reducing the thickness of the large-size substrates. Accordingly, the manufacturing processes can be simplified, and the reliability can be improved.

### Modification 1 of Third Embodiment

Next, modification 1 of the third embodiment will be described.

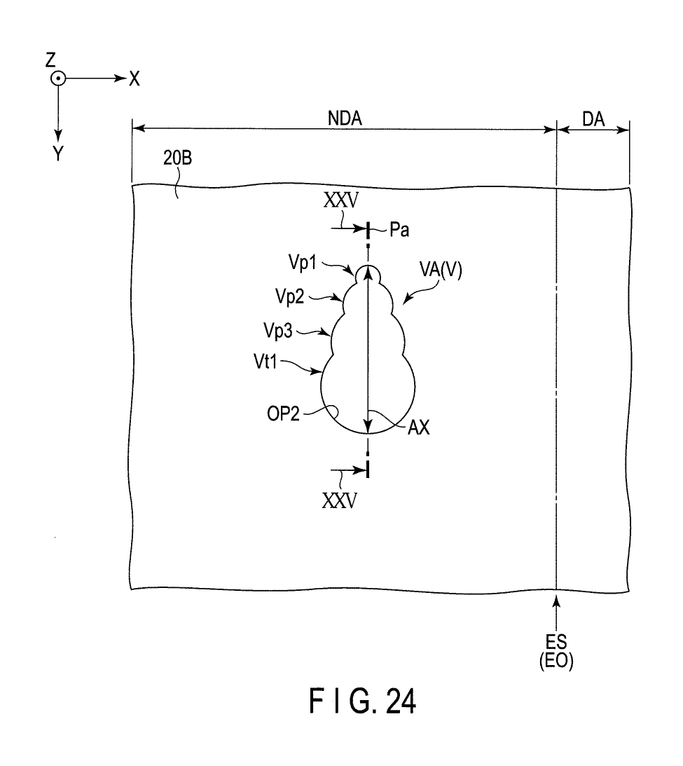

As shown in FIG. 24, modification 1 differs from the third embodiment in the shape of the second open end OP2. The contact hole V has one first hole portion Vt1, one third concavity portion Vp3, one second concavity portion Vp2 and one first concavity portion Vp1.

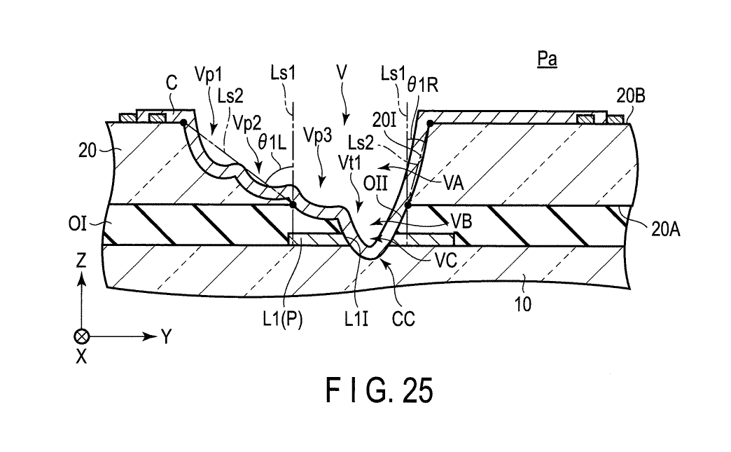

As shown in FIG. 25, the angle θ1L is greater than or equal to 45° and the angle θ1R is less than 45° on the first plane Pa. On the first plane Pa, the inner peripheral surfaces 20I and OII have steps on the left side of the drawing but do not have steps on the right side of the drawing.

In modification 1 also, the first plane Pa satisfies 45°≤θ1L. Therefore, the same effect as that produced from the third embodiment can also be produced from modification 1.

### Fourth Embodiment

Next, the fourth embodiment will be described. The display device DSP of the fourth embodiment differs from that of the third embodiment in that the second conductive layer L2 is connected to the first conductive layer L1 without an intervention of the connecting material C and that the contact hole V is formed by laser beam application and etching.

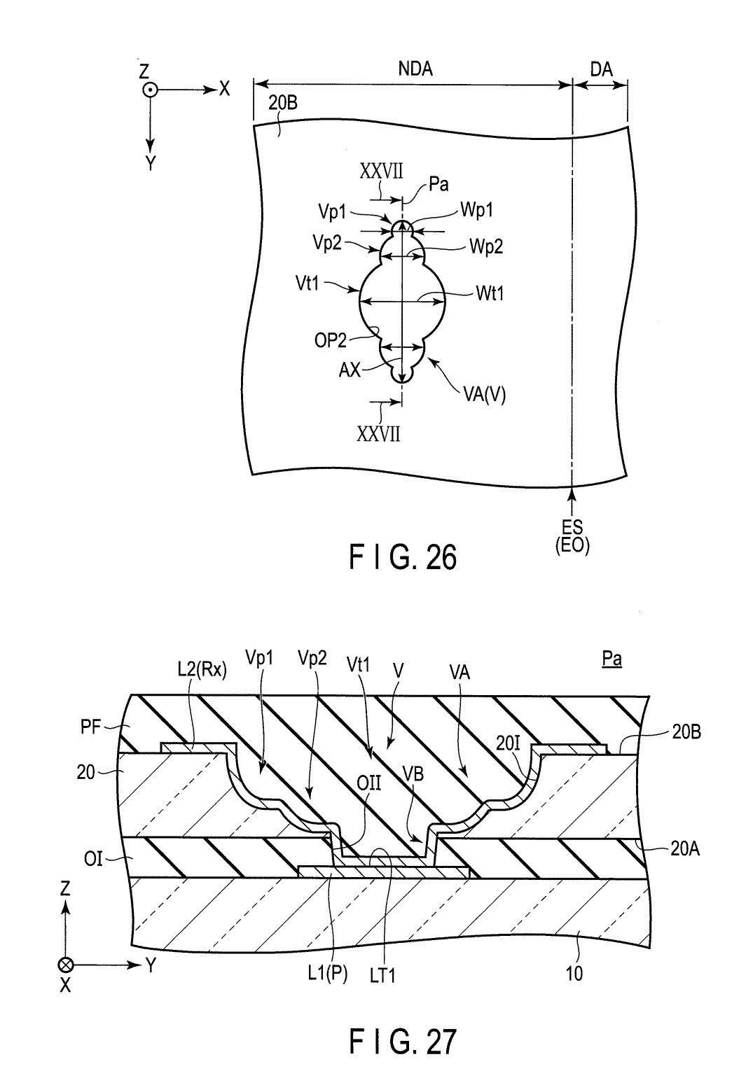

As shown in FIG. 26, the contact hole V (the first hole VA) has the major axis AX in a planar view. The contact hole V has the first hole portion Vt1, the first concavity portions Vp1 and the second concavity portions Vp2. The first hole portion Vt1, the first concavity portions Vp1 and the second concavity portions Vp2 are arranged along the major axis AX and are continuous with each other.

As shown in FIG. 27, the contact hole V has the first hole VA and the second hole VB. The first hole VA is formed of the first hole portion Vt1, the first concavity portions Vp1 and the second concavity portions Vp2. The second hole VB is independent from the first hole portion Vt1 and is continuous with the first hole portion Vt1. On the first plane Pa, the inner peripheral surface 20I of the second basement 20 in the first hole VA has steps. The steps are formed in locations of connection between the first hole portion Vt1 and the second concavity portions Vp2 and in locations of connection between the second concavity portions Vp2 and the first concavity portions Vp1. Since the inner peripheral surface 20I has steps, the connecting material C can be excellently retained on the inner peripheral surface 20I.

The second conductive layer L2 covers the contact hole V (the first hole VA and the second hole VB). In the present embodiment, the second conductive layer L2 completely covers the contact hole V and is in contact with the upper surface LT1 of the pad P. The display panel PNL of the present embodiment is formed without the filling material FI. The protection material PF fills the hollow in the contact hole V and covers the second conductive layer L2 inside and around the contact hole V.

The connecting material C (for example, silver) is not provided inside the contact hole V or around the contact hole V. Therefore, it is not necessary to give consideration to light reflection on the connecting material C inside and around the contact hole V. In the present embodiment, consideration should only be given to light reflection on the second conductive layer L2 inside and around the contact hole V.

For example, if the second conductive layer L2 has a multilayer structure including a metal layer formed of metal and a transparent conductive layer formed of a transparent conductive material, and the transparent conductive layer contacts the protection material PF, it is possible to obtain a reflection light interference effect from the effect of the transparent conductive layer.

The reflection light interference effect is produced when interference occurs between first reflection light reflected on the surface of the transparent conductive layer and second reflection light reflected on the interface between the transparent conductive layer and the metal layer. Therefore, if the phase difference between the first reflection light and the second reflection light is 0.5 wavelengths, the first reflection light and the second reflection light are canceled out, and the intensity of reflection light will be reduced. As described above, the second conductive layer L2 itself suppresses reflection light.

Therefore, it is not necessary to provide a member different from the second conductive layer L2 as a light-shielding measure inside and around the contact hole V. For example, it is not necessary to provide the filling material FI colored in black inside and around the contact hole V in place of the protection material PF.

Next, a manufacturing method of the display device DSP of the present embodiment will be described. Here, a method of forming the contact hole V will be described.

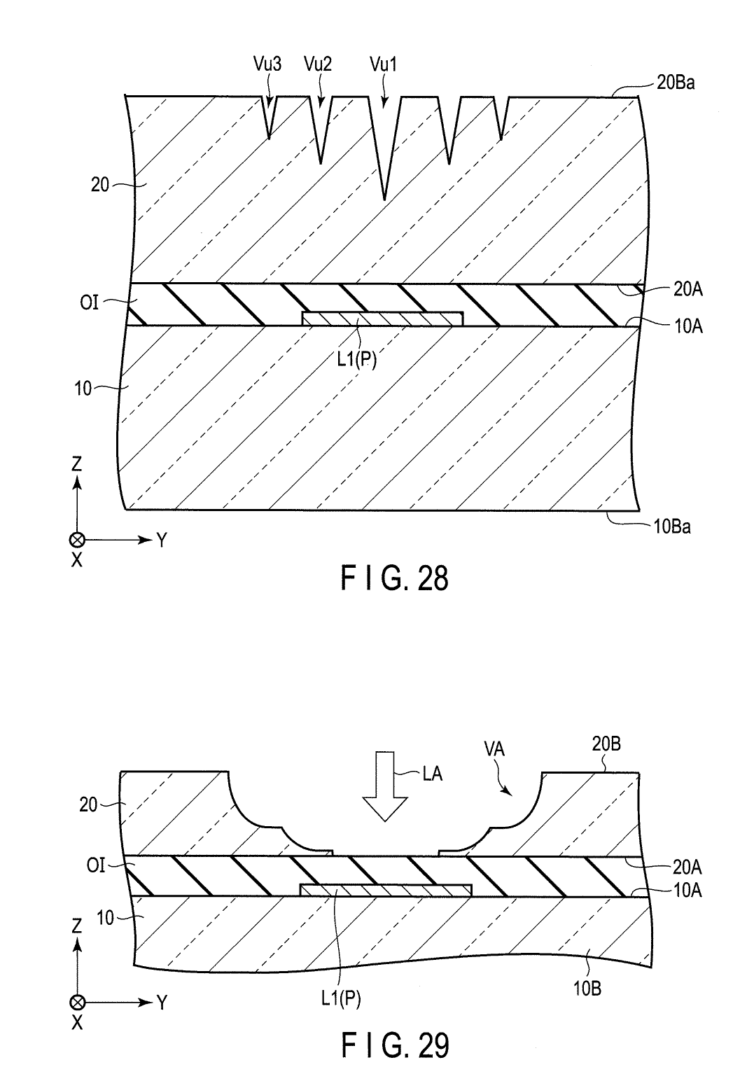

As shown in FIG. 28, a laser beam is applied to a plurality of irradiation regions of the second basement 20 from above the second surface 20Ba. Accordingly, a plurality of different-sized concavities Vu1, Vu2 and Vu3 are formed in the second basement 20.

The concavity Vu1 corresponds to the first hole portion Vt1 and has the largest size among the concavities Vu1, Vu2 and Vu3. For example, the concavity Vu1 is the deepest hole and has the largest opening area on the second surface 20Ba. The concavities Vu2 correspond to the second concavity portions Vp2. The concavities Vu3 correspond to the first concavity portions Vp1 and have the smallest size among the concavities Vu1, Vu2 and Vu3. For example, the concavity Vu3 is the shallowest hole and has the smallest opening area on the second surface 20Ba.

As described above, after the concavities Vu1, Vu2 and Vu3, which open on the second surface 20Ba, are formed in the second basement 20, the first basement 10 and the second basement 20 are etched (by polishing processing, sliming processing, etc.). In this way, the thicknesses of the first basement 10 and the second basement 20 are reduced. The first basement 10 can have a fourth surface 10B located on the third surface 10A side from the fourth surface 10Ba. The second basement 20 can have the second surface 20B located on the first surface 20A side from the second surface 20Ba. In the second basement 20, etching is promoted not only on the second surface 20Ba but also inside the concavities Vu1, Vu2 and Vu3.

As shown in FIG. 29, the first hole VA of the contact hole V is formed, accordingly. In the present embodiment also, the first hole VA is formed by laser beam application and etching. Therefore, cracks originating from the first hole VA can be prevented in the second basement 20.

Subsequently, a laser beam LA is applied to the organic insulating layer OI inside the first hole VA from above the display panel PNL. In this way, part of the organic insulating layer OI which is irradiated with the laser beam LA sublimes, and the second hole VB is formed in the organic insulating layer OI. As a result, the contact hole V is formed.

As shown in FIG. 27, a conductive layer is formed inside the contact hole V and on the second surface 20B, and the conductive layer is patterned. For example, the conductive layer has a multilayer structure of a metal layer and a transparent conductive layer. In this way, the second conductive layer L2 is formed inside the contact hole V and on the second surface 20B. After that, the protection material PF is formed inside the contact hole V, and on the second surface 20B and the second conductive layer L2.

In the display device DSP of the fourth embodiment which is structured as described above also, the same contact hole V as that of the third embodiment can be obtained, and the same effect as that produced from the third embodiment can be produced. Further, since the second conductive layer L2 is disposed after the contact hole V is formed, the connecting material C does not exist inside and around the contact hole V, and the first conductive layer L1 and the second conductive layer L2 are directly electrically connected to each other. According to this structure, it is not necessary to take any light-shielding measure for providing the connecting material C. Further, the contact resistance between the first conductive layer L1 and the second conductive layer L2 improves.

### Modification 1 of Fourth Embodiment

Next, modification 1 of the fourth embodiment will be described.

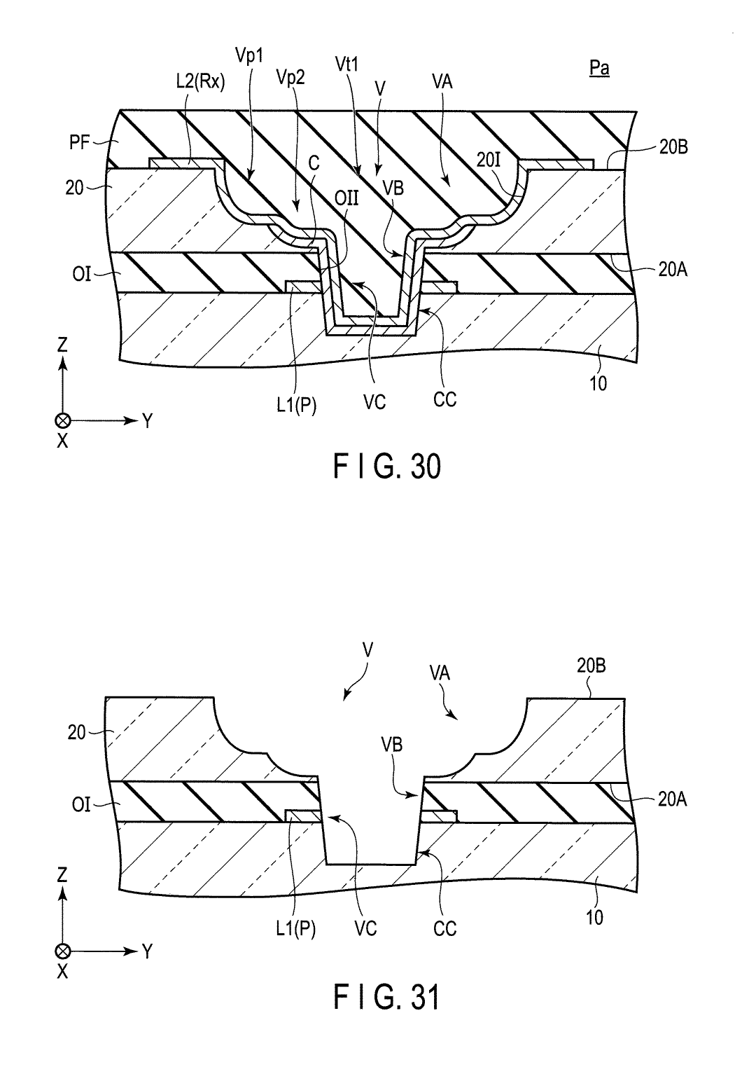

As shown in FIG. 30, modification 1 differs from the fourth embodiment in that the contact hole V further has the third hole VC and the concavity CC and that the connecting material C is used. The first hole VA is formed of the first hole portion Vt1, the first concavity portions Vp1 and the second concavity portions Vp2. The second hole VB, the third hole VC and the concavity CC are independent from the first hole portion Vt1. Among the second hole VB, the third hole VC and the concavity CC, the second hole VB is continuous with the first hole portion Vt1. The connecting material C is adhered to the surface of the contact hole V and is in contact with the first conductive layer L1 (the pad P). When the connecting material C is formed, the application amount of a metal material can be adjusted. In any case, the connecting material C should contact the first conductive layer L1 (the pad P).

The second conductive layer L2 covers the contact hole V and the connecting material C and is in contact with the connecting material C. In modification 1, the second conductive layer L2 completely covers the contact hole V and the connecting material C. Therefore, the second conductive layer L2 is electrically connected to the first conductive layer L1 (the pad P) via the connecting material C. Further, the second conductive layer L2 also functions as a light-shielding layer for the connecting material C.

The manufacturing method of the display device DSP of modification 1 can adopt the manufacturing method of the display device DSP of the fourth embodiment. Here, differences from the manufacturing method of the fourth embodiment will be described.

As shown in FIG. 31, in modification 1, not only the second hole VB, but also the third hole VC penetrating through the first conductive layer L1 and the concavity CC formed in the first basement 10 are formed by the application of the laser beam LA. As shown in FIG. 30, before the second conductive layer L2 is formed, the connecting material C is formed inside the contact hole V.

In modification 1 also, the same first hole VA as that of the fourth embodiment can be obtained, and the same effect as that produced from the fourth embodiment can be produced.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions. It is possible to combine two or more embodiments if needed.

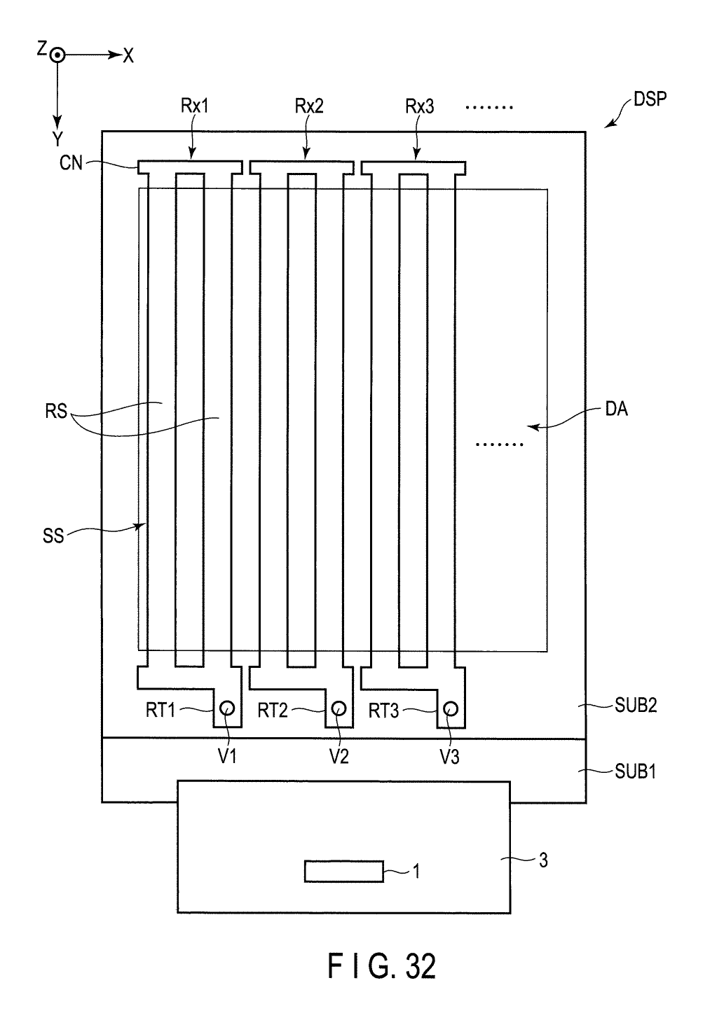

For example, as shown in FIG. 32, the detection electrodes Rx1, Rx2, Rx3 . . . may extend in the second direction Y and may be arranged at intervals in the first direction X. The main bodies RS extend in the second direction Y in the display area DA. Further, the terminals RT1, RT2, RT3 . . . are located between the display area DA and the circuit board 3 and are arranged at intervals in the first direction X. The contact holes V1, V2, V3 . . . are arranged at intervals in the first direction X. If the contact hole V has the major axis AX, the major axis AX should preferably be parallel to the first direction X.

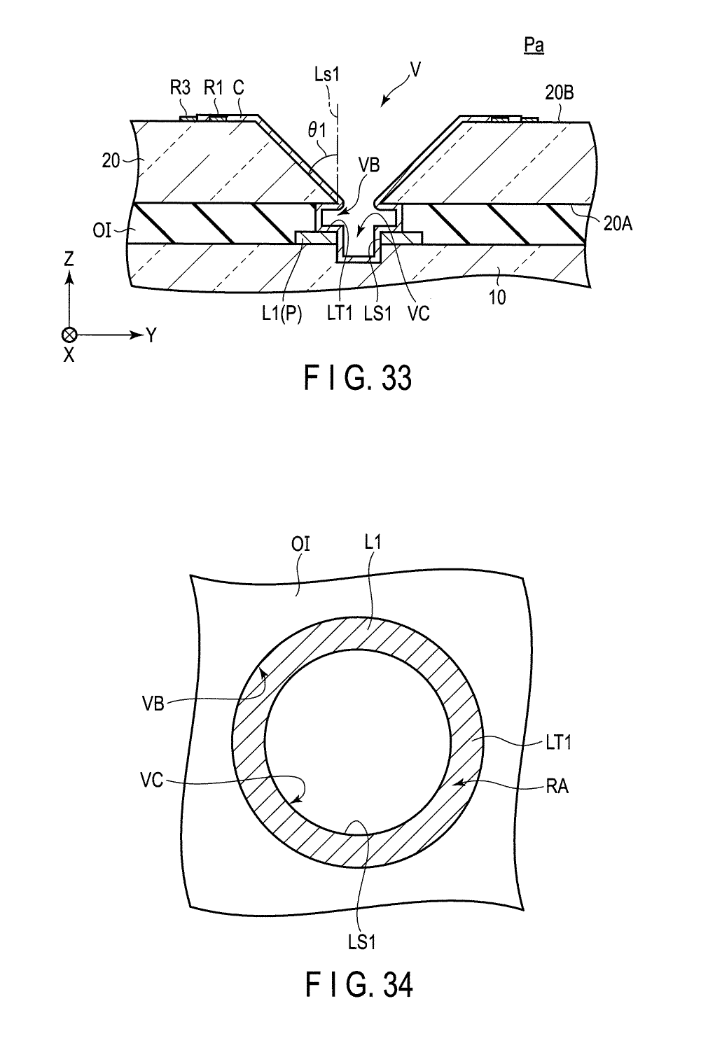

Further, as shown in FIG. 33, in the first substrate SUB1, the connecting material C may contact an inner surface LS1 of the first conductive layer L1 in the third hole VC of the contact hole V and also the upper surface LT1 of the first conductive layer L1.

FIG. 34 is a plan view showing the first conductive layer L1 and the organic insulating layer OI when viewed from the second basement 20 side. Only the first conductive layer L1 and the organic insulating layer OI are shown in FIG. 34. A region of the upper surface LT1 which is not covered with the organic insulating layer OI is shaded by rising diagonal lines. As shown in FIG. 34, the size of the second hole VB is larger than the size of the third hole VC in a planar view. A region RA of the upper surface LT1 of the first conductive layer L1 which contacts the connecting material C is a region which is not covered with the organic insulating layer OI due to the second hole VB. Here, the region RA has the shape of a ring in a planar view. The region RA is shaded by diagonal lines in the drawing. In a planar view, the second hole VB and the third hole VC may have the shape of a perfect circle, but may be not limited to have this shape, and may be another circular shape such as the shape of an ellipse or may have a shape other than a circular shape.

What is claimed is:

1. A display device comprising:
a first substrate including a first basement and a first conductive layer;
a second substrate including a second basement and a second conductive layer, the second basement including a first surface which is opposed to the first conductive layer and is at a distance from the first conductive layer, a second surface which is located on an opposite side from the first surface, and a first hole which penetrates between the first surface and the second surface,
the second conductive layer provided on the second surface; and
a connecting material which electrically connects the first conductive layer and the second conductive layer via the first hole, wherein
on a virtual first plane which passes through the first hole and is parallel to a normal of the first surface, an angle between a first straight line which extends along the normal and a second straight line which connects a first open end on a first surface side of the first hole and a second open end on a second surface side of the first hole is greater than or equal to 45°.

2. The display device of claim 1, wherein on the first plane, an angle between the second surface and the second straight line is greater than or equal to 135°.

3. The display device of claim 1, wherein angles between all tangent lines of an inner peripheral surface of the second basement in the first hole and the first straight line are greater than or equal to 45°.

4. The display device of claim 1, wherein on the first plane, an inner peripheral surface of the second basement in the first hole projects to the second surface side from the second straight line.

5. The display device of claim 1, wherein the second conductive layer and the connecting material are formed of a same material and are integrally formed with each other.

6. The display device of claim 1, wherein on the first plane, an inner peripheral surface of the second basement in the first hole has steps.

7. The display device of claim 6, wherein
the first hole has a major axis in a planar view,
the major axis is parallel to the first plane,
the inner peripheral surface of the second basement does not have steps on a virtual second plane which passes through the first hole, is orthogonal to the first plane, and is parallel to the normal.

8. The display device of claim 1, further comprising:
a display area; and
a non-display area provided along edges of the display area,
wherein
the first hole is located in the non-display area, and has a major axis which is parallel to one of the edges of the display area which is opposed to the first hole, and
the major axis is parallel to the first plane.

9. The display device of claim 1, further comprising:
an organic insulating layer located between the first conductive layer and the second basement; and
a contact hole having the first hole and a second hole which penetrates the organic insulating layer and is continuous with the first hole,
wherein
the first plane passes through the contact hole, and
on the first plane, an angle between the first straight line and a third straight line which connects a third open end on a first basement side of the contact hole and the second open end is greater than or equal to 45°.

10. The display device of claim 9, wherein on the first plane, an inner peripheral surface of the second basement and an inner peripheral surface of the organic insulating layer in the contact hole have steps.

11. The display device of claim 10, wherein
the contact hole has a first hole portion which penetrates the second basement and the organic insulating layer, and a first concavity which opens on the second surface, does not open on the first surface, and is continuous with the first hole,
the contact hole has a major axis in a planar view,
the first hole portion and the first concavity are arranged along the major axis, and
a width of the first hole portion is greater than a width of the first concavity in a direction orthogonal to the major axis in a planar view.

12. The display device of claim 1, further comprising:
an organic insulating layer located between the first conductive layer and the second basement; and
a contact hole including the first hole and a second hole which penetrates the organic insulating layer and is continuous with the first hole,
wherein
the connecting material is adhered to a surface of the contact hole and is in contact with the first conductive layer, and
the second conductive layer covers the contact hole and the connecting material.

13. The display device of claim 1, further comprising:
a display area; and
a non-display area provided along outer edges of the display area,
wherein
the second conductive layer includes a detection electrode which includes a main body located in the display area and a terminal located in the non-display area and connected to the main body, and
the connecting material is electrically connected to the terminal.

14. The display device of claim 13, further comprising a detector which is electrically connected to the first conductive layer and reads a sensor signal output from the detection electrode.

15. The display device of claim 13, wherein the first substrate includes a sensor drive electrode which crosses the detection electrode.
